(19) United States
(12) Patent Application Publication
(10) Pub. No.: US 2026/0170748 A1
(43) Pub. Date: Jun. 18, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yuto YOSHIDA, Kanagawa (JP)

(21) Appl. No.: 19/392,443

(22) Filed: Nov. 18, 2025

(30) Foreign Application Priority Data
Dec. 13, 2024 (JP) 2024-218842

(51) Int. Cl. G06T 15/20; G06T 7/55; G06T 19/20

(52) U.S. Cl. CPC G06T 15/20; G06T 7/55; G06T 19/20; G06T 2207/10024; G06T 2207/20081; G06T 2210/62; G06T 2219/2012

(57) ABSTRACT

To provide a high-accuracy virtual viewpoint image while decreasing the data amount of a 3D Gaussian model. An information processing apparatus according to the present disclosure: obtains captured images obtained by performing image capturing on a target space in directions different from one another and camera parameters corresponding to each captured image; sets, based on the captured images and the camera parameters, initial values of parameters of a 3D Gaussian model including 3D Gaussian distributions that include at least one 3D Gaussian distribution having a value of a density corresponding to a negative opacity and at least one 3D Gaussian distribution having a value of a density corresponding to a positive opacity; and obtains a trained 3D Gaussian model reproducing the target space by optimizing the parameters of the 3D Gaussian model through training based on the captured images and the camera parameters.

### BACKGROUND

### Field of the Technology

The present disclosure relates to a technique of estimating spatial information based on a plurality of captured images obtained by performing image capturing from a plurality of viewpoints.

There are techniques of estimating spatial information based on a plurality of captured images obtained by performing image capturing from a plurality of viewpoints (hereinafter, referred to as “multi-viewpoint images”) and camera parameters corresponding to the image capturing. There are also techniques of generating an image corresponding to a view from a viewpoint that is virtual (hereinafter, referred to as a “virtual viewpoint”) (hereinafter, referred to as a “virtual viewpoint image”) using the estimated spatial information. A technique called 3D Gaussian Splatting is disclosed in “3D Gaussian Splatting for Real-Time Radiance Field Rendering” (hereinafter, referred to as “Non Patent Literature 1”). According to the technique disclosed in Non Patent Literature 1 (hereinafter, referred to as “related art”), a plurality of three-dimensional Gaussian distributions (hereinafter, referred to as “3D Gaussian distributions”) each of which is assigned color information and density information and has an extent in spatial directions are first arranged in a three-dimensional space. Then, based on information pertaining to the plurality of arranged 3D Gaussian distributions, an image corresponding to the same viewpoint as a viewpoint from which a captured image is captured is drawn. Then, information on the space (spatial information) is estimated by optimizing the parameters of the 3D Gaussian distributions in such a manner as to decrease the difference between the image and the captured image. In the following description, a set of 3D Gaussian distributions being the plurality of arranged 3D Gaussian distributions will be denoted as a “3D Gaussian model.”

### SUMMARY

In the related art, 3D Gaussian distributions included in a 3D Gaussian model each include parameters pertaining to coordinates, a size, a rotation, a density, and a color. As a result, a 3D Gaussian model including a large number of 3D Gaussian distributions has an enormous amount of data, resulting in an increased amount of computation to train the 3D Gaussian model and an increased processing load in reading, writing, or data transfer of the 3D Gaussian model.

Nevertheless, the shape of some object that is present in the above-described three-dimensional space and represented by the spatial information may require a large number of 3D Gaussian distributions to be included in a 3D Gaussian model to represent the shape. A typical example of the above-described case is, for example, an object having a hole such as a through hole. The inventor recognize that, in a case where the shape of an object having a hole is to be represented with a 3D Gaussian model, the related art fails to represent the hole with 3D Gaussian distributions. The inventor recognize that a method of the related art represents the hole by, for example, arranging many small 3D Gaussian distributions in the vicinity of the hole, thus requiring a large number of 3D Gaussian distributions to be included in the 3D Gaussian model.

The present disclosure is made to solve the above-described problem and is directed to providing a high-accuracy virtual viewpoint image while decreasing the amount of data of a 3D Gaussian model.

An information processing apparatus according to the present disclosure includes one or more hardware processors; and one or more memories storing one or more programs configured to be executed by the one or more hardware processors, the one or more programs including instructions for: obtaining a plurality of captured images and camera parameters, the plurality of captured images being obtained by performing image capturing on a target space in a plurality of directions different from one another, the camera parameters corresponding to each of the plurality of captured images; setting, based on the captured images and the camera parameters, initial values of parameters of a 3D Gaussian model that includes a plurality of 3D Gaussian distributions, the plurality of 3D Gaussian distributions including at least one 3D Gaussian distribution having a value of a density corresponding to a negative opacity and at least one 3D Gaussian distribution having a value of a density corresponding to a positive opacity; and obtaining a trained 3D Gaussian model that reproduces the space target being by optimizing the parameters of the 3D Gaussian model through training based on the captured images and the camera parameters.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams for describing examples of 3D Gaussian distributions included in a 3D Gaussian model according to related art;

FIG. 2 is a block diagram illustrating an example of a logical configuration of an information processing apparatus according to a first embodiment;

FIG. 3 is a block diagram illustrating an example of a hardware configuration of the information processing apparatus according to the first embodiment;

FIG. 4 is a flowchart illustrating an example of a processing flow of the information processing apparatus according to the first embodiment;

FIGS. 5A to 5E are diagrams for describing an example of an operation of the information processing apparatus according to the first embodiment;

FIG. 6 is a flowchart illustrating an example of a flow of a process of setting initial values of 3D Gaussian distributions performed by a setting unit according to the first embodiment;

FIG. 7 is a flowchart illustrating an example of a flow of a process of training a 3D Gaussian model performed by a training unit according to the first embodiment;

FIG. 8 is a graph illustrating an example of a relation between density and opacity of a 3D Gaussian distribution according to the first embodiment;

FIG. 9 is a flowchart illustrating an example of a flow of a process of updating an arrangement of 3D Gaussian distributions performed by the training unit according to the first embodiment;

FIGS. 10A to 10H are diagrams for describing an example of the process of updating the arrangement of 3D Gaussian distributions performed by the training unit according to the first embodiment;

FIG. 11 is a block diagram illustrating an example of a logical configuration of an information processing apparatus according to a second embodiment;

FIG. 12 is a flowchart illustrating an example of a processing flow of the information processing apparatus according to the second embodiment;

FIGS. 13A to 13D are diagrams for describing an example of an operation of the information processing apparatus according to the second embodiment; and

FIGS. 14A to 14E are diagrams for describing an example of a rendering process performed by a drawing unit according to the second embodiment.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

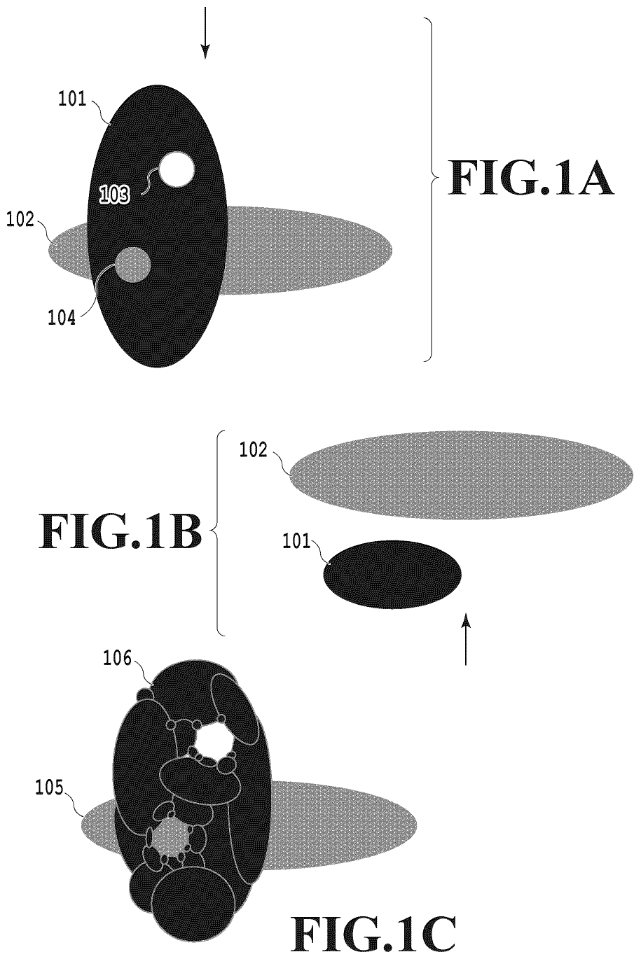

FIGS. 1A to 1C are diagrams for describing examples of 3D Gaussian distributions included in a 3D Gaussian model according to the related art. FIGS. 1A and 1B illustrate examples of the shapes of objects 101 and 102 that are present in a space being a target that may be represented by spatial information (hereinafter, referred to as a “target space”) and the arrangement of the objects 101 and 102. Specifically, FIG. 1A is an arrow view of the target space as viewed from the direction of the arrow illustrated in FIG. 1B, and FIG. 1B is an arrow view of the target space as viewed from the direction of the arrow illustrated in FIG. 1A. As illustrated in FIG. 1A, the object 101 has two holes 103 and 104.

FIG. 1C illustrates an example of 3D Gaussian distributions 105 and 106 included in the 3D Gaussian model according to the related art, which may represent the shapes of the objects 101 and 102, respectively. The object 102 is in an ellipsoidal shape, and the shape of the object 102 as viewed in the direction of the arrow illustrated in FIG. 1B may be represented by one 3D Gaussian distribution 105. In contrast, since the object 101 has the two holes 103 and 104, the shape of the object 101 as viewed in the direction of the arrow illustrated in FIG. 1B needs to be represented by many 3D Gaussian distributions 106 that are arranged avoiding the holes 103 and 104. As a result, the 3D Gaussian model according to the related art includes many 3D Gaussian distributions 106, resulting in an increase in the data amount of the 3D Gaussian model.

### First Embodiment

In a first embodiment, an aspect in which 3D Gaussian distributions the values of which indicating their densities are negative values are set, and a 3D Gaussian model including the 3D Gaussian distributions is trained in a case of the objects 101 and 102 illustrated in FIGS. 1A and 1B as an example will be described. Hereinafter, a 3D Gaussian distribution the value of which indicating its density is a negative value will be referred to as a “negative-density 3D Gaussian distribution.” A 3D Gaussian model including a negative-density 3D Gaussian distribution may represent the shape of an object being complex in shape with fewer 3D Gaussian distributions compared with a conventional 3D Gaussian model, that is, a 3D Gaussian model that is the combination of only 3D Gaussian distributions the values of which indicating their densities are positive values.

In the present disclosure, a 3D Gaussian distribution having a density corresponding to a negative opacity is defined below. In the present embodiment, a negative density will be assigned to a negative opacity. In the present disclosure, a 3D Gaussian distribution having a density corresponding to a negative opacity will also be denoted as a “negative-density 3D Gaussian distribution.” Note that the opacity is a value that is defined so as to correspond to the density of a 3D Gaussian distribution. The opacity represents a degree or extent to which a 3D Gaussian distribution blocks the drawing of an object at, for example, a position behind the 3D Gaussian distribution as seen from a virtual viewpoint in a case where the 3D Gaussian distribution is drawn from the virtual viewpoint. A 3D Gaussian distribution the value of which indicating its density is a positive value will be referred to as a “positive-density 3D Gaussian distribution.” A 3D Gaussian distribution having a positive density corresponding to a positive opacity will also be denoted as a “positive-density 3D Gaussian distribution.”

### <Logical Configuration of Information Processing Apparatus>

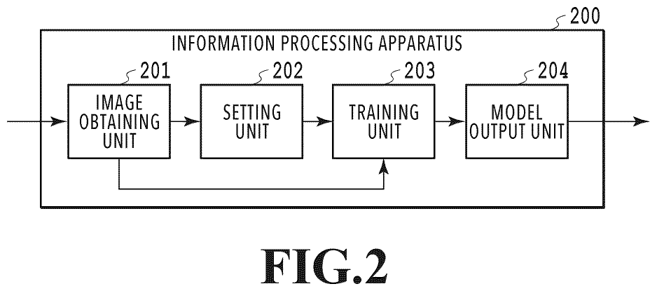

With reference to FIGS. 2 to 9, an information processing apparatus 200 according to the first embodiment will be described. The information processing apparatus 200 first obtains a plurality of captured images (multi-viewpoint images) that are obtained by capturing the target space including the object 101 and the object 102 from a plurality of viewpoints. Then, based on the captured images constituting the multi-viewpoint images, the information processing apparatus 200 sets the initial values of a 3D Gaussian model including a negative-density 3D Gaussian distribution. The information processing apparatus 200 then updates the parameters of the 3D Gaussian model including the negative-density 3D Gaussian distribution such that the difference between a drawn image generated using the 3D Gaussian model and a captured image is reduced, until a given termination condition of training is satisfied. Finally, after the given termination condition of training is satisfied, the information processing apparatus 200 outputs the trained 3D Gaussian model as a computer-readable file.

With reference to FIG. 2, a logical configuration of the information processing apparatus 200 according to the first embodiment will be described. FIG. 2 is a block diagram illustrating an example of the logical configuration of the information processing apparatus 200 according to the first embodiment. The information processing apparatus 200 includes an image obtaining unit 201, a setting unit 202, a training unit 203, and a model output unit 204.

The image obtaining unit 201 obtains data on at least two captured images (multi-viewpoint images) that are obtained by capturing the target space from at least two directions different from each other and obtains information pertaining to image capturing conditions under which the captured images are captured. In the following description, it is assumed that the captured images are RGB images, as an example. In the following description, it is also assumed that the information pertaining to the image capturing conditions includes the position of a viewpoint from which each captured image is captured (hereinafter, referred to as an “image capturing viewpoint”), the direction of a line of sight at the image capturing viewpoint, a rotation angle, a focal length, and a resolution. The position of an image capturing viewpoint is a position of an image capturing apparatus that captures the corresponding captured image, the direction of a line of sight is an attitude of the image capturing apparatus, and the rotation angle is the size of a rotation angle around a rotation axis that is an optical axis of the image capturing apparatus. The focal length is a focal length of an optical system of the image capturing apparatus, and the resolution is, for example, the number of pixels of the captured image.

The setting unit 202 sets initial parameters of a 3D Gaussian model. The parameters of a 3D Gaussian model are equivalent to spatial information that includes information pertaining to the number of 3D Gaussian distributions, and the position, size, rotation angle, density, and color of each of the 3D Gaussian distributions and may represent the target space. The training unit 203 trains the 3D Gaussian model. Specifically, the training unit 203 projects each 3D Gaussian distribution included in the 3D Gaussian model onto a drawing plane corresponding to an image capturing viewpoint to generate a drawn image, calculates the difference between the drawn image and the corresponding captured image, and updates the parameters of the 3D Gaussian model in such a manner as to decrease the difference. The model output unit 204 outputs the 3D Gaussian model on which the training process by the training unit 203 has been completed (trained 3D Gaussian model) in the form of a computer-readable file.

### <Hardware Configuration of Information Processing Apparatus>

The processes performed by the units included in the information processing apparatus 200 as its logical configuration are performed by processing hardware that is built in the information processing apparatus 200, such as an application specific integrated circuit (ASIC). The processes may be performed by software using an arithmetic processing unit built in the information processing apparatus 200, such as a central processor unit (CPU) or a graphics processor unit (GPU), and a memory.

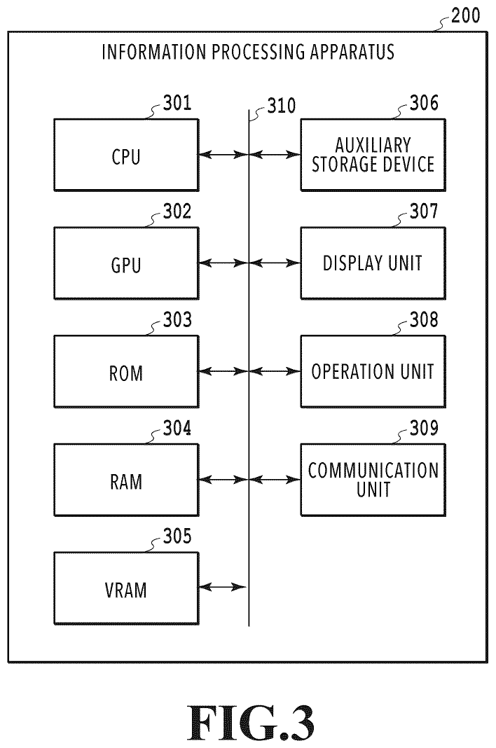

With reference to FIG. 3, a hardware configuration of the information processing apparatus 200 in a case where the processes performed by the units included in the information processing apparatus 200 as its logical configuration are performed by the execution of the software will be described. FIG. 3 is a block diagram illustrating an example of the hardware configuration of the information processing apparatus 200 according to the first embodiment. The information processing apparatus 200 is configured with a computer. The computer includes, as its hardware configuration, a CPU 301, a GPU 302, a ROM 303, a RAM 304, a VRAM 305, and an auxiliary storage device 306. As the hardware configuration, the computer also includes a display unit 307, an operation unit 308, a communication unit 309, and a bus 310.

The CPU 301 controls the computer with a program or data stored in the ROM 303, the auxiliary storage device 306, or the like, thus causing the computer to function as the units included in the information processing apparatus 200 as its logical configuration. The ROM 303 stores a program, various types of data, and the like that need not be changed. The auxiliary storage device 306 is configured with, for example, a hard disk drive or the like. The auxiliary storage device 306 stores a program, various types of data such as image data and sound data. The RAM 304 operates as a work area for the CPU 301. The RAM 304 temporarily stores a program and data supplied from the ROM 303 or the auxiliary storage device 306, data supplied from the outside via the communication unit 309, or the like.

The GPU 302 controls, in cooperation with the CPU 301, the computer with the program or data stored in the ROM 303, the auxiliary storage device 306, or the like, thus causing the computer to function as the units included in the information processing apparatus 200 as its logical configuration. The VRAM 305 is a memory used for graphics and operates as a work area for the GPU 302. The VRAM 305 temporarily stores a program and data supplied from the ROM 303, the auxiliary storage device 306, or the like. Note that information processing apparatus 200 may include one or more pieces of dedicated processing hardware other than the CPU 301 and the GPU 302, and the one or more pieces of processing hardware may execute at least a part of processing performed by the CPU 301 or the GPU 302. Examples of the dedicated processing hardware include an ASIC, a field programmable gate array (FPGA), and a digital signal processor (DSP).

The display unit 307 is configured with a liquid crystal display, a light-emitting diode (LED), or the like. The display unit 307 displays a graphical user interface (GUI) for a user to operate the information processing apparatus 200, a GUI for browsing the state of the information processing apparatus 200, or the like. The operation unit 308 is configured with a keyboard, a mouse, a touch-sensitive panel, or the like. Receiving an operation from the user, the operation unit 308 inputs one of various instructions that corresponds to the operation into the CPU 301. The CPU 301 also operates as a display control unit that controls the display unit 307 and as an operation control unit that controls the operation unit 308.

The communication unit 309 is used in communication between the information processing apparatus 200 and an external apparatus. For example, if the information processing apparatus 200 is connected to the external apparatus in a wired connection, a communication cable is connected to the communication unit 309. If the information processing apparatus 200 has a function of wireless communication with the external apparatus, the communication unit 309 includes an antenna. The bus 310 connects the components of the above-described hardware configuration of the information processing apparatus 200 together so as to enable the components to communicate with one another, and transfers information. In the following description, it is assumed that the display unit 307 and the operation unit 308 are present inside the information processing apparatus 200. However, at least one of the display unit 307 and the operation unit 308 may be present outside the information processing apparatus 200 as a separate apparatus.

### <Operation of Information Processing Apparatus>

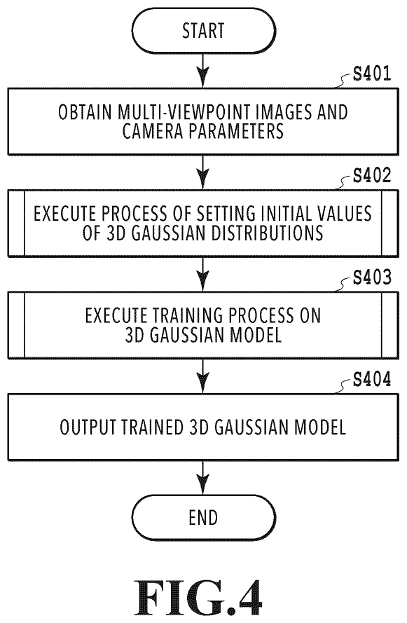

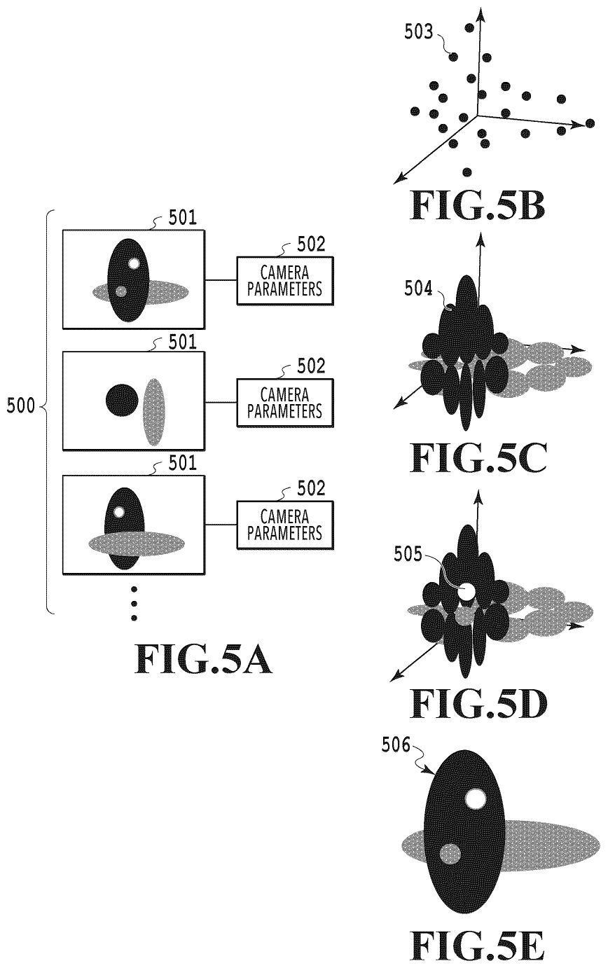

With reference to FIGS. 4 to 9, the operation of the information processing apparatus 200 will be described. FIG. 4 is a flowchart illustrating an example of a processing flow of the information processing apparatus 200 according to the first embodiment. FIGS. 5A to 5E are diagrams for describing an example of the operation of the information processing apparatus 200 according to the first embodiment. Specifically, FIG. 5A illustrates an example of a plurality of captured images obtained by the information processing apparatus 200 (multi-viewpoint images 500) and camera parameters corresponding to each of captured images 501 constituting the multi-viewpoint images 500. FIGS. 5B to 5E will be described later. In the following description, the symbol “S” means a step.

First, in S401, the image obtaining unit 201 obtains data on a plurality of captured images obtained by capturing the target space in at least two directions different from each other (the multi-viewpoint images 500) and obtains camera parameters 502 indicating image capturing conditions corresponding to each captured image 501. The camera parameters 502 include, as parameters, information pertaining to the position, attitude, focal length, principal point, and resolution of an image capturing apparatus that captures the captured image 501. The multi-viewpoint images 500 are obtained by image capturing that is performed with a plurality of image capturing apparatuses arranged at positions different from one another and is performed, for example, in synchronization with one another. The multi-viewpoint images 500 may be obtained by image capturing that is performed with at least one image capturing apparatus a plurality of times while the position and attitude of the image capturing apparatus are changed. Specifically, for example, the captured images 501 constituting the multi-viewpoint images 500 may be frames constituting a moving image obtained by image capturing that is performed with one image capturing apparatus while the orientation of the one image capturing apparatus to objects being a capturing target is changed with time.

In the following description, it is assumed that the captured images 501 are rectangular images as illustrated in FIG. 5A. However, the shape of the captured images 501 is not limited to this. For example, the captured images 501 may be omnidirectional images. In this case, the image obtaining unit 201 obtains camera parameters that correspond to the omnidirectional images. In the following description, it is assumed that the camera parameters are prepared in advance, and the image obtaining unit 201 obtains the camera parameters from the image capturing apparatuses and the like together with data on the captured image. However, the method of obtaining the camera parameters is not limited to this. For example, the image obtaining unit 201 may obtain the camera parameters that correspond to the captured images 501 through estimation using a localization algorithm for estimating an image-capturing position based on a captured image, such as simultaneous localization and mapping (SLAM).

After S401, in S402, the setting unit 202 executes the process of setting initial values of initial 3D Gaussian distributions to be included in a 3D Gaussian model as a training target, based on the data on the multi-viewpoint images 500 and the camera parameters corresponding to each captured image 501 obtained in S401. Specifically, based on the data on the multi-viewpoint images 500 and the camera parameters corresponding to each captured image 501, the setting unit 202 sets initial positions and initial parameters of the initial 3D Gaussian distributions. The process of setting the initial values will be described in detail later. Next, in S403, the training unit 203 executes a process of training the 3D Gaussian model, the initial values of which are set in S402, based on the data on the multi-viewpoint images 500 and the camera parameters corresponding to each captured image obtained in S401. The process of training the 3D Gaussian model will be described in detail later.

Next, in S404, the model output unit 204 outputs the trained 3D Gaussian model, which is obtained as a result of the training process in S403, in the form of a computer-readable file. The format of the file output by the model output unit 204 may be the PLY file format or may be another file format. After S404, the information processing apparatus 200 terminates the processes in the flowchart illustrated in FIG. 4.

### <Process of Setting Initial Values of 3D Gaussian Distributions>

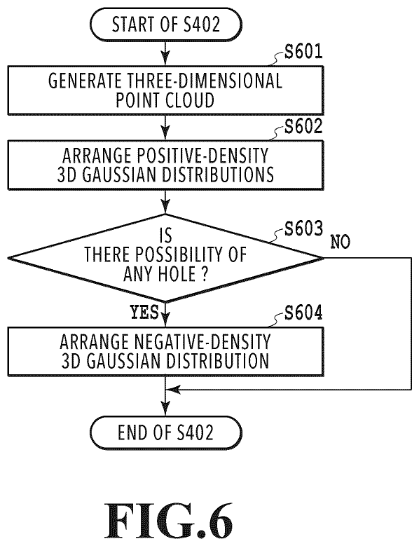

FIG. 6 is a flowchart illustrating an example of a flow of the process of setting the initial values of the 3D Gaussian distributions performed by the setting unit 202 according to the first embodiment. FIG. 6 is a flowchart illustrating an example of the flow of the setting process in S402 illustrated in FIG. 4. The processes in the flowchart illustrated in FIG. 6 are executed after the process of S401 illustrated in FIG. 4. First, in S601, the setting unit 202 executes the following process based on the data on the multi-viewpoint images 500 and the camera parameters corresponding to each captured image 501 obtained in S401. Specifically, based on the data on and the camera parameters of each captured image 501, the setting unit 202 generates (reconstructs) a three-dimensional point cloud by matching sets of feature points of the captured images with one another across viewpoints according to the Structure from Motion (SfM) technique. FIG. 5B illustrates an example of a three-dimensional point cloud 503 that is generated by the setting unit 202. If the camera parameters are not obtained in S401, the setting unit 202 may obtain the camera parameters in the generating process in S601 by estimating the positional relationship among the image capturing apparatuses and the attitudes of the image capturing apparatuses based on the multi-viewpoint images 500.

Next, in S602, based on the three-dimensional point cloud 503 obtained in S601 and the captured images 501 obtained in S401, the setting unit 202 generates and arranges positive-density 3D Gaussian distributions at points included in the three-dimensional point cloud 503. Specifically, for each of the points included in the three-dimensional point cloud 503, the setting unit 202 first determines the variances of a positive-density 3D Gaussian distribution to be arranged at the point, that is, the size of the positive-density 3D Gaussian distribution to be arranged at the point, based on the distances from the point to other points present in the vicinity of the point. The setting unit 202 then determines the color of a positive-density 3D Gaussian distribution to be arranged at each of the points included in the three-dimensional point cloud 503, based on the color values of pixels in each of the captured images 501. The setting unit 202 then generates and arranges the positive-density 3D Gaussian distribution that corresponds to each of the points included in the three-dimensional point cloud 503, and the size and color of which are determined. FIG. 5C illustrates an example of a plurality of positive-density 3D Gaussian distributions 504 based on the three-dimensional point cloud 503, which are generated and arranged by the setting unit 202.

Next, in S603, the setting unit 202 determines whether the possibility that any hole is present in an object being a capturing target is high or low. Specifically, the setting unit 202 first determines whether there exist a plurality of 3D Gaussian distributions 504 adjacent to one another and bearing high similarities in color to one another among the plurality of 3D Gaussian distributions 504 set in S602. If it is determined that there are no plurality of 3D Gaussian distributions 504 adjacent to one another and bearing high similarities in color to one another, the setting unit 202 determines that the possibility that any hole is present in the object being a capturing target is high.

If it is determined that there exist a plurality of 3D Gaussian distributions 504 adjacent to one another and bearing high similarities in color to one another, the setting unit 202 further executes the following determining process. Specifically, in this case, the setting unit 202 determines whether there exists any 3D Gaussian distribution 504 at a position at a predetermined distance from an apex of each of the plurality of 3D Gaussian distributions 504. If it is determined that any 3D Gaussian distribution 504 is present at the position, the setting unit 202 determines that the possibility that any hole is present in the object being a capturing target is low. If it is determined that any 3D Gaussian distribution 504 is not present at the position, the setting unit 202 determines that the possibility that any hole is present at the position in the object being a capturing target is high. If it is determined in S603 that the possibility that any hole is present in the object being a capturing target is high, the setting unit 202 executes the process of S604. If it is determined in S603 that the possibility that any hole is present in the object being a capturing target is low, the setting unit 202 terminates the processes of the flowchart illustrated in FIG. 6, that is, the process of S402 illustrated in FIG. 4, without executing the process of S604.

In S604, the setting unit 202 generates and arranges a negative-density 3D Gaussian distribution 505 at a position at a predetermined distance from each of the plurality of 3D Gaussian distributions 504 adjacent to one another and bearing high similarities in color to one another. Specifically, the setting unit 202 generates a negative-density 3D Gaussian distribution the color of which is a statistic such as the mean value or median of colors of the plurality of 3D Gaussian distributions 504 adjacent to one another and bearing high similarities in color. FIG. 5D illustrates an example of the negative-density 3D Gaussian distribution 505, which is generated by the setting unit 202. Note that, in this case, the setting unit 202 may replace the plurality of positive-density 3D Gaussian distributions 504 adjacent to one another and bearing high similarities in color to one another with one large, positive-density 3D Gaussian distribution. In this case, for example, the setting unit 202 generates and arranges the negative-density 3D Gaussian distribution 505 in the positive-density 3D Gaussian distribution. After S604, the setting unit 202 terminates the processes of the flowchart illustrated in FIG. 6, that is, the process of S402 illustrated in FIG. 4. Through the above processes, the initial values of the initial 3D Gaussian distributions to be included in the 3D Gaussian model being a training target are set.

The present embodiment is described assuming that the initial, positive-density 3D Gaussian distributions 504 are arranged at the points included in the three-dimensional point cloud 503, which is generated according to the SfM. However, the method of arranging the initial 3D Gaussian distributions 504 is not limited to this. For example, the setting unit 202 may specify the position of the surface of an object being a capturing target according to the multi-view stereo technique and may generate and arrange initial, positive-density 3D Gaussian distributions at positions of a plurality of small surface segments into which the specified surface of the object is divided.

Alternatively, for example, the setting unit 202 may generate and arrange initial, positive-density 3D Gaussian distributions the image-capturing regions and resolutions of which are set in the target space uniformly, or may generate and arrange initial, positive-density 3D Gaussian distributions in the target space randomly. If a region corresponding to the background of a captured image is known, or in a case where a region corresponding to the foreground of a captured image may be obtained by foreground-background separation, the setting unit 202 may perform the following process. Specifically, in this case, for example, the setting unit 202 excludes, from the initial 3D Gaussian distributions, a 3D Gaussian distribution projected onto a region corresponding to the background or a 3D Gaussian distribution not projected onto a region corresponding to the foreground, among the plurality of 3D Gaussian distributions arranged in the target space regularly or randomly. The exclusion of such a 3D Gaussian distribution from the initial 3D Gaussian distributions removes an unnecessary 3D Gaussian distribution before the execution of the process of training a 3D Gaussian model. Thus, the amount of computation in the training process may be decreased.

The setting unit 202 may perform the process of reducing the number of the initial, positive-density 3D Gaussian distributions to decrease the amount of computation and the amount of data in the training process. Specifically, for example, the setting unit 202 replaces, among the initial, positive-density 3D Gaussian distributions arranged in the above-described manner, 3D Gaussian distributions close to one another in position and bearing high similarities in color to one another with one large 3D Gaussian distribution according to the K-means clustering technique or the like. This reduces the number of the 3D Gaussian distributions compared with a case where this process is not performed. Thus, the amount of computation and the amount of data in the training process may be decreased.

### <Training Process on 3D Gaussian Model>

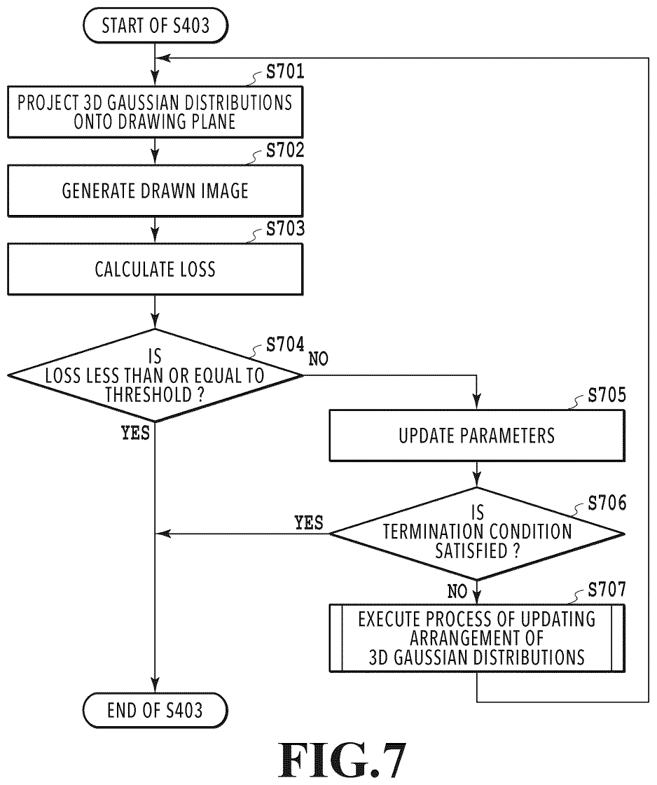

FIG. 7 is a flowchart illustrating an example of a flow of the process of training a 3D Gaussian model performed by the training unit 203 according to the first embodiment. FIG. 7 is a flowchart illustrating an example of the flow of the training process in S403 illustrated in FIG. 4. The processes in the flowchart illustrated in FIG. 7 are executed after the process of S402 illustrated in FIG. 4. First, in S701, the training unit 203 projects 3D Gaussian distributions included in the 3D Gaussian model being a training target onto a drawing plane corresponding to each image capturing viewpoint. Specifically, the training unit 203 projects the 3D Gaussian distributions onto the drawing plane corresponding to each image capturing viewpoint by converting the 3D Gaussian distributions into two-dimensional Gaussian distributions (hereinafter, referred to as a “2D Gaussian distribution”) based on, for example, Equation (1).

$$\begin{matrix}[ Equation 1 ] & \\ {\sum }^{′} = {JR}_{cw} \sum {R}_{cw}^{T} {J}^{T} & Equation ( 1 )\end{matrix}$$

Here, Σ denotes a three-dimensional covariance matrix corresponding to a 3D Gaussian distribution, and Σ′ denotes a two-dimensional covariance matrix corresponding to a projected 2D Gaussian distribution. In addition, R_{cw} denotes a rotation matrix of a virtual image capturing apparatus arranged at a virtual viewpoint (hereinafter, referred to as a “virtual camera”). In addition, J denotes a Jacobian matrix. The Jacobian matrix J may be defined by, for example, Equation (2).

$$\begin{matrix}[ Equation 2 ] & \\ J = [ \begin{matrix}{f}_{x} / z & 0 & - {f}_{x} x / {z}^{2} \\ 0 & {f}_{y} / x & - {f}_{y} y / {z}^{2}\end{matrix} ] & Equation ( 2 )\end{matrix}$$

Here, (fₓ, f_{y}) denotes the value of a focal length of the virtual camera, and (x, y, z) denotes coordinates of a three-dimensional point to be projected. After S701, in S702, the training unit 203 generates, for each drawing plane, a rendered image corresponding to an image capturing viewpoint corresponding to the drawing plane (hereinafter, referred to as a “drawn image”) through a rendering process in which values of the projected 3D Gaussian distributions are accumulated. Specifically, the training unit 203 calculates the color values of the pixels of the drawn image by, for example, integrating the values of the projected 3D Gaussian distributions in descending order of closeness to the virtual viewpoint, based on, for example, Equations (3) and (4).

$$\begin{matrix}[ Equation 3 ] & \\ c ( {p}_{c} ) = {\sum }_{i ∈ N} {c}_{i} {f}_{i}^{2 D} ( {p}_{c} ) {\prod }_{j = 1}^{i - 1} ( 1 - {f}_{j}^{2 D} ( {p}_{c} ) ) & Equation ( 3 )\end{matrix}$$

$$\begin{matrix}[ Equation 4 ] & \\ {f}_{i} ( {p}_{c} ) = tanh ( {α}_{i} ) exp ( \frac{1}{2} \text{?} ) & Equation ( 4 )\end{matrix}$$

$$\text{?} \text{indicates text missing or illegible when filed}$$

Here, pe denotes a value indicating the position of a pixel in a drawn image to be generated (hereinafter, referred to as a “pixel position”), and C(p_{c}) denotes a color value calculated by accumulating the 2D Gaussian distributions projected onto the pixel position p_{c}. In addition, cᵢ denotes the value of the color of the i-th projected 2D Gaussian distribution, and fᵢ^{2D}(p_{c}) denotes the opacity of the i-th projected 2D Gaussian distribution at the pixel position p_{c}. In addition, tanh(x) is the hyperbolic tangent function, αᵢ denotes the density of the i-th projected 2D Gaussian distribution, and μᵢ is the mean value of the i-th projected 2D Gaussian distribution.

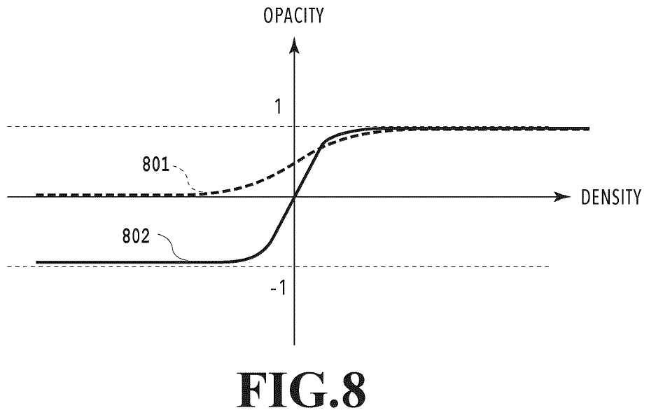

FIG. 8 is a graph illustrating an example of the relation between the density and opacity of a 3D Gaussian distribution according to the first embodiment. In a case of a conventional 3D Gaussian Splatting, that is, 3D Gaussian Splatting disclosed in Non Patent Literature 1, positive opacities are assigned to all densities di using a sigmoid function 801. In contrast, in the present embodiment, negative opacities are assigned to the densities of 2D Gaussian distributions onto which negative-density 3D Gaussian distributions are projected, using, for example, a hyperbolic tangent function 802 illustrated in FIG. 8 as an example.

In the following description, it is assumed that the relation between the densities and opacities of 2D Gaussian distributions onto which 3D Gaussian distributions are projected is defined by the hyperbolic tangent function 802 illustrated in FIG. 8 as an example. However, the relation is not limited to this. For example, the relation may be defined by a scaled sigmoid function the range of which is expanded from [0, 1] of a sigmoid function to [−1, 1]. The scaled sigmoid function may be represented by, for example, Equation (5).

$$\begin{matrix}[ Equation 5 ] & \\ {σ}_{scaled} ( x ) = 2 / ( 1 + {e}^{- x} ) - 1 & Equation ( 5 )\end{matrix}$$

Here, x denotes a value indicating the density, and σ_{scaled} is a value indicating the opacity. The present embodiment is described assuming that the relation is defined such that the value of the opacity is zero in a case where the value of the density is zero, and the value of the opacity is negative in a case where the value of the density is negative. However, the relation between the density and opacity of a 2D Gaussian distribution onto which a 3D Gaussian distribution is projected is not limited to this. Specifically, the relation may be defined such that the value of the opacity is positive or negative in a case where the value of the density is zero, or the value of the opacity may be defined such that the range is positive in a part of a domain where the value of the density is negative. After S702, in S703, the training unit 203 calculates the difference between each of drawn images generated in S702 and a captured image corresponding to an image capturing viewpoint that is identical to the image capturing viewpoint corresponding to the drawn image, as a loss. The loss may be calculated using a loss function L, which is shown as Equation (6), as an example.

$$\begin{matrix}[ Equation 6 ] & \\ L = ( 1 - λ ) {L}_{1} + {λL}_{D - ssim} & Equation ( 6 )\end{matrix}$$

Here, λ denotes a coefficient for adjusting the weights of two types of losses, and L₁ denotes a loss based on the difference between the color value of a drawn image and the color value of a captured image. L_{D-ssim} denotes a loss based on the structural similarity index measure (SSIM), which is an index for evaluating the structural similarity between images. The loss L₁ may be calculated using, for example, Equation (7), and the loss L_{D-ssim} may be calculated using, for example, Equation (8).

$$\begin{matrix}[ Equation 7 ] & \\ {L}_{1} = \frac{1}{N} {\sum }_{i = 1}^{N} \vert {c}_{i} - {\hat{c}}_{i} \vert & Equation ( 7 )\end{matrix}$$

$$\begin{matrix}[ Equation 8 ] & \\ {L}_{D - ssim} = 1 - SSIM ( Img , Img \hat{} ) & Equation ( 8 )\end{matrix}$$

Here, N denotes the number of pixels of the drawn image and the captured image corresponding to the drawn image, cᵢ denotes the color value of the i-th pixel in the captured image, cᵢ\hat{ } denotes the color value of the i-th pixel in the drawn image, Img denotes the captured image, and Img\hat{ } denotes the drawn image. Note that cᵢ\hat{ } may take a negative value due to a negative opacity corresponding to a negative-density 3D Gaussian distribution, and the values of some of the pixels in the drawn image may consequently be negative values. In a case where the values of some of the pixels in the drawn image are negative values as above, exceptional processing in which the negative values are changed to a predetermined value such as zero may be performed before Img\hat{ } is input into the SSIM. If such exceptional processing is not performed, that is, if the values of the pixels in an image to be processed in the SSIM may take a negative value, some of constant terms used in the arithmetic operations of the SSIM are in general defined in accordance with the range of values that the pixels may take. The above-described case thus requires the redefinition of the some of the constant terms. The above-described exceptional processing eliminates the need of the redefinition of the some of the constant terms.

In the present embodiment, the loss function L is defined using Equation (1) as an example. However, the loss function L is not limited to this. For example, the loss function L may be defined such that a loss is produced in a case where the accumulated opacity at a given pixel takes a negative value. Specifically, for example, an adjustment term L_{negativeF}, which is shown as Equation (9) as an example, may be added to the right side of the loss function L shown as Equation (6). In a case where the accumulated opacity is negative, the addition of the adjustment term L_{negativeF} may curb the influence of a negative-density 3D Gaussian distribution corresponding to a negative opacity. For example, an adjustment term L_{negativeColor}, which is shown as Equation (10) as an example, may be added to the right side of the loss function L shown as Equation (6). If at least one of these adjustment terms is added, the coefficient λ for adjusting the weights of the terms may be changed in accordance with the added at least one of the adjustment terms, or another coefficient for adjusting the weight of the added at least one of the adjustment terms may be added.

$$\begin{matrix}[ Equation 9 ] & \\ {L}_{negativeP} = \frac{1}{2} ( \vert 1 - {\prod }_{j = 0}^{N} ( 1 - {f}_{j}^{2 D} ) \vert - ( 1 - {\prod }_{j = 0}^{N} ( 1 - {f}_{j}^{2 D} ) ) ) & Equation ( 9 )\end{matrix}$$

$$\begin{matrix}[ Equation 10 ] & \\ {L}_{nwegativeColor =} \frac{1}{2} ( \frac{1}{N} {\sum }_{i = 1}^{N} ( \vert {\hat{c}}_{i} \vert - {\hat{c}}_{i} ) ) & Equation ( 10 )\end{matrix}$$

After S703, in S704, the training unit 203 determines whether the value of the loss calculated in S703 is less than or equal to a given threshold. If the value of the loss is determined to be less than or equal to the threshold in S704, the training unit 203 terminates the processes of the flowchart illustrated in FIG. 7, that is, the process of S403. If the value of the loss is determined to be not less than nor equal to the threshold, that is, greater than the threshold, the training unit 203 executes the process of S705. Note that the threshold determination using the value of the loss is performed here as an example of a termination condition. However, the termination condition is not limited to this. For example, the termination condition may include a rate of reduction of the loss calculated in S803 from the previous loss. In this case, for example, in a case where the rate of reduction of the loss is less than or equal to a predetermined threshold, the training unit 203 terminates the process of S403, and in a case where the rate of reduction of the loss is greater than the predetermined threshold, the training unit 203 executes the process of S705.

In S705, based on the value of the loss calculated in S703, the training unit 203 optimizes parameters of a 3D Gaussian model by updating the parameters in accordance with a contribution to an increase in the loss. Specifically, the training unit 203 updates a parameter pertaining to at least any one of the position, rotation angle, size, color, and density of each of the 3D Gaussian distributions included in the 3D Gaussian model. The training unit 203 stores the update count of the 3D Gaussian distributions, and increments the update count in a case where the 3D Gaussian distributions are updated.

After S705, in S706, the training unit 203 determines whether the termination condition of the training process is satisfied. Specifically, for example, the training unit 203 determines whether the termination condition of the training process is satisfied by determining whether the above-described update count of the 3D Gaussian distributions exceeds a predetermined count. If the update count of the 3D Gaussian distributions exceeds the predetermined count, the training unit 203 determines that the termination condition of the training process is satisfied, and if the update count of the 3D Gaussian distributions does not exceed the predetermined count, the training unit 203 determines that the termination condition of the training process is not satisfied.

If it is determined in S706 that the termination condition of the training process is satisfied, the training unit 203 terminates the processes of the flowchart illustrated in FIG. 7, that is, the process of S403. If it is determined in S706 that the termination condition of the training process is not satisfied, the training unit 203 executes the process of S707. Note that the determination of the termination condition of the training process is not limited to the determination based on the update count of the 3D Gaussian distributions. For example, the training unit 203 may determine that the termination condition of the training process is satisfied if an elapsed time from the start of the training process exceeds a predetermined threshold.

In S707, the training unit 203 executes the process of updating the arrangement of the 3D Gaussian distributions. The process of updating the arrangement of the 3D Gaussian distributions in S707 is executed every time the parameters of the 3D Gaussian distributions are updated in S705. The process of updating the arrangement of the 3D Gaussian distributions in S707 will be described in detail later. After S707, the training unit 203 returns to S701 and repeatedly executes the processes from S701 to S707 as appropriate.

### <Process of Updating Arrangement of 3D Gaussian Distributions>

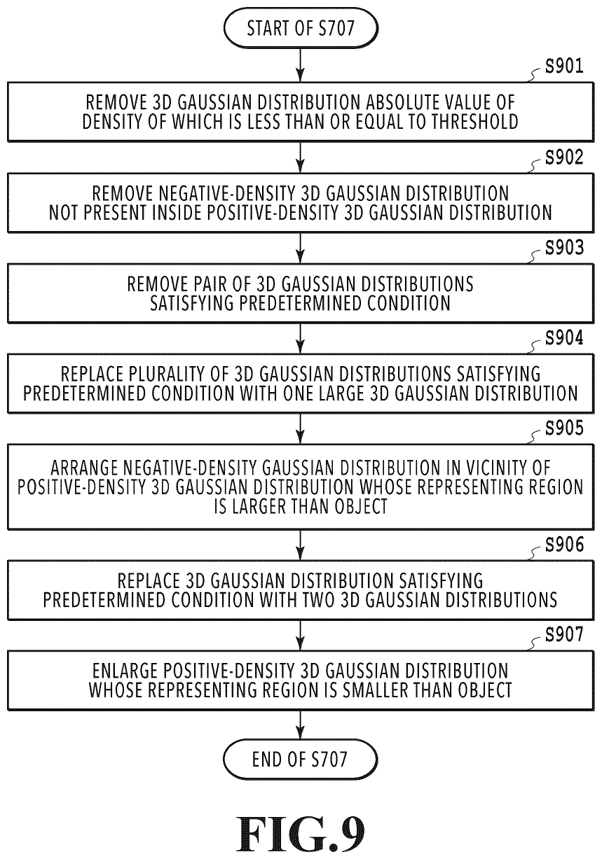

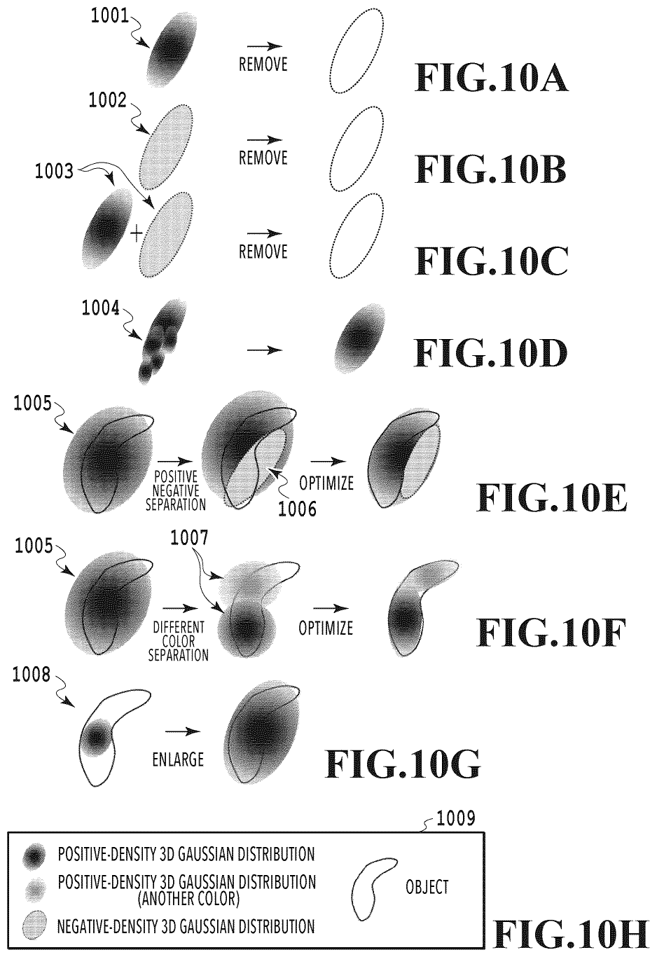

With reference to FIG. 9 and FIGS. 10A to 10H, the process of updating the arrangement of the 3D Gaussian distributions in S707 will be described. FIG. 9 is a flowchart illustrating an example of a flow of the process of updating the arrangement of 3D Gaussian distributions performed by the training unit 203 according to the first embodiment. FIG. 9 is a flowchart illustrating an example of the flow of the update process in S707 illustrated in FIG. 7. FIGS. 10A to 10H are diagrams for describing the process of updating the arrangement of 3D Gaussian distributions performed by the training unit 203 according to the first embodiment. Note that FIGS. 10A to 10G are diagrams for describing the processes of steps in the flowchart illustrated in FIG. 9, and FIG. 10H illustrates legends 1009 for figures illustrated in FIG. 10A to FIG. 10G. The processes of the flowchart illustrated in FIG. 9 are executed if it is determined in S706 illustrated in FIG. 7 that the termination condition of the training process is not satisfied.

First, in S901, the training unit 203 removes, from among the 3D Gaussian distributions included in a 3D Gaussian model, a 3D Gaussian distribution 1001 the absolute values of the densities of which are less than or equal to a given threshold. The removal of 3D Gaussian distributions that contribute little to the quality of a virtual viewpoint image to be generated using the 3D Gaussian model may decrease the amount of data and the amount of computation of the subsequent training process.

Next, in S902, the training unit 203 removes a negative-density 3D Gaussian distribution 1002 that is not present inside a positive-density 3D Gaussian distribution, that is, not contained by the positive-density 3D Gaussian distribution. In a case where there are no positive-density 3D Gaussian distributions containing negative-density 3D Gaussian distributions, which decrease opacity, a drawn image including pixels having negative color values may be generated by the rendering process. The removal of the negative-density 3D Gaussian distribution 1002 not present inside the positive-density 3D Gaussian distribution may inhibit the generation of a drawn image including pixels having negative color values.

Next, in S903, the training unit 203 removes a pair of 3D Gaussian distributions that satisfy a predetermined condition. Specifically, the training unit 203 removes, from among pairs of overlapping 3D Gaussian distributions, a pair 1003 of 3D Gaussian distributions that bear sufficiently high similarities in parameters other than density and have densities different in sign. This is because, if such a pair of 3D Gaussian distributions overlap each other, their opacities are canceled, and as a result, the representations based on the pair of 3D Gaussian distributions in a drawn image are canceled. The removal of such a pair of 3D Gaussian distributions may decrease the amount of data and the amount of computation of the subsequent training process.

Next, in S904, the training unit 203 replaces a plurality of 3D Gaussian distributions that satisfy a predetermined condition with one large 3D Gaussian distribution. Specifically, the training unit 203 replaces a plurality of 3D Gaussian distributions 1004 that bear high similarities to one another in parameters pertaining to color and density and adjacent to one another in position with one 3D Gaussian distribution. In an example illustrated in FIG. 10D, the 3D Gaussian distributions 1004 are illustrated as positive-density 3D Gaussian distributions. However, the process of S904 may be applied to negative-density 3D Gaussian distributions. The replacement of a plurality of 3D Gaussian distributions with one 3D Gaussian distribution may reduce the total number of 3D Gaussian distributions included in a 3D Gaussian model while inhibiting a degradation in the quality of a virtual viewpoint image generated using the 3D Gaussian model. As a result, the amount of data and the amount of computation of the subsequent training process may be decreased.

Next, in S905, in a case where there are no negative-density 3D Gaussian distributions in the vicinity of a positive-density 3D Gaussian distribution 1005 whose representing region by the 3D Gaussian distribution is larger than an object, the training unit 203 generates and arranges a negative-density 3D Gaussian distribution 1006 in the vicinity of the 3D Gaussian distribution 1005. The combination of the positive-density 3D Gaussian distribution 1005 and the negative-density 3D Gaussian distribution 1006 may decrease the difference between the object in a complex shape and the representation by the 3D Gaussian distributions. That is, the combination of a positive-density 3D Gaussian distribution and a negative-density 3D Gaussian distribution may represent, in a virtual viewpoint image, the shape of an object that is difficult to represent only by the optimization of the position, rotation angle, size, color, and density of one positive-density 3D Gaussian distribution.

Next, in S906, the training unit 203 replaces one 3D Gaussian distribution that satisfies a predetermined condition with a plurality of 3D Gaussian distributions. Specifically, in a case where one 3D Gaussian distribution 1005 has an error in color in an opposite direction in a color space, the training unit 203 replaces the 3D Gaussian distribution 1005 with two 3D Gaussian distributions 1007 having different colors. In an example illustrated in FIG. 10F, the positive-density 3D Gaussian distribution 1005 is replaced with the two positive-density 3D Gaussian distributions 1007. However, the replacement is not limited to this.

For example, one 3D Gaussian distribution may be replaced with three or more 3D Gaussian distributions 1007. One negative-density 3D Gaussian distribution may be replaced with a plurality of negative-density 3D Gaussian distributions if the one negative-density 3D Gaussian distribution satisfies the above-described condition. The replacement of one 3D Gaussian distribution satisfying the above-described condition with a plurality of 3D Gaussian distributions may represent, in a virtual viewpoint image, colors of an object that are difficult to represent only by the optimization of the position, rotation angle, size, color, and density of one 3D Gaussian distribution. That is, differences from actual colors of an object may be decreased in a region corresponding to the object in a virtual viewpoint image generated using a 3D Gaussian model.

Next, in S907, the training unit 203 enlarges the variances (size) of a positive-density 3D Gaussian distribution 1008 whose representing region is smaller than an object in accordance with the size of the object. The enlargement of the variances (size) of a 3D Gaussian distribution according to a size of an object may represent the object using one 3D Gaussian distribution. After S907, the training unit 203 terminates the processes of the flowchart illustrated in FIG. 9, that is, the process of S707 illustrated in FIG. 7. Through the processes from S901 to S907 illustrated in FIG. 9, it is possible to correct an event that is difficult to correct only by the optimization of parameters pertaining to 3D Gaussian distributions included in a 3D Gaussian model.

The information processing apparatus 200 configured as described above enables the decrease of the number of 3D Gaussian distributions necessary to represent the target space, that is, the total number of 3D Gaussian distributions being a training target included in a 3D Gaussian model, compared with the related art disclosed in Non Patent Literature 1. That is, the information processing apparatus 200 enables a high-accuracy virtual viewpoint image to be obtained while the amount of data of a 3D Gaussian model is decreased compared with the related art.

Specifically, for example, if the information processing apparatus 200 reduces the number of 3D Gaussian distributions necessary to represent the target space by n compared with the related art, the reduced amount of data of the 3D Gaussian model is as follows. In this case, assume that, for example, parameters pertaining to each of the 3D Gaussian distributions are each represented as a 32-bit floating point number and are each in a data format that is represented by three-dimensional spherical harmonics, a data amount of 464×n(=8 bytes×59 parameters×n) bytes may be reduced. Note that 59 parameters include 3 parameters for representing three-dimensional coordinates, 3 parameters for representing directional scales, 4 parameters for representing a rotation in quaternion notation, 1 parameter for representing a density, and 48 (=16× 3 colors) parameters as the coefficients of a spherical harmonics for representing a color.

### Modification 1 of First Embodiment

In the first embodiment, an aspect in which negative-density 3D Gaussian distributions are treated individually as with positive-density 3D Gaussian distributions has been described. In this case, if a negative-density 3D Gaussian distribution is independently arranged outside a positive-density 3D Gaussian distribution, a drawn image including pixels having negative color values, which require the exceptional processing, is generated. Thus, the negative-density 3D Gaussian distribution may be arranged such that the negative-density 3D Gaussian distribution is managed in association with the positive-density 3D Gaussian distribution. In the following description, the positive-density 3D Gaussian distribution and the negative-density 3D Gaussian distribution that is managed in association with the positive-density 3D Gaussian distribution will be denoted as a parent Gaussian distribution and a child Gaussian distribution, respectively, for ease of description.

For example, an information processing apparatus 200 according to Modification 1 of the first embodiment (hereinafter, simply referred to as an “information processing apparatus 200”) manages the parent Gaussian distribution and the child Gaussian distribution such that the child Gaussian distribution is present inside the parent Gaussian distribution by limiting the position and size of the child Gaussian distribution. It is assumed that the information processing apparatus 200 determines parameters pertaining to the density and color of the child Gaussian distribution based on parameters pertaining to the density and color of the parent Gaussian distribution, in the generation of the initial 3D Gaussian distributions. This may decrease events in which the value of densities accumulated in the rendering process is negative or events in which the color values of pixels obtained by the rendering process are negative. As a result, the occurrences of events that require the exceptional processing may be decreased.

In the process of updating the arrangement of 3D Gaussian distributions in S707 according to the present modification, for example, the following processes are performed. In a case where a parent Gaussian distribution is removed in the processes of S901 to S903, a child Gaussian distribution associated with the parent Gaussian distribution is also removed. In a case where a plurality of positive-density 3D Gaussian distributions are integrated into one 3D Gaussian distribution in the process of S904, a child Gaussian distribution that is associated with any one of the plurality of 3D Gaussian distributions before the integration is reassociated with the 3D Gaussian distribution after the integration, as a parent Gaussian distribution.

In a case where another negative-density 3D Gaussian distribution is generated in the vicinity of a positive-density 3D Gaussian distribution in the process of S905, the positive-density 3D Gaussian distribution is regarded as a parent Gaussian distribution, and the generated negative-density 3D Gaussian distribution is regarded as a child Gaussian distribution and is associated with the parent Gaussian distribution. In a case where a parent Gaussian distribution is replaced with a plurality of positive-density 3D Gaussian distributions in the process of S906, a 3D Gaussian distribution that is the closest to the position of a child Gaussian distribution among the plurality of 3D Gaussian distributions replaced with is regarded as a parent Gaussian distribution and is newly associated with the child Gaussian distribution.

### Second Embodiment

In the present embodiment, an aspect in which a virtual viewpoint image is generated using the above-described trained 3D Gaussian model the amount of data of which is reduced by using negative-density 3D Gaussian distributions corresponding to negative opacities will be described. In the following description, for ease of description, it is assumed that opacities are assigned to densities such that a negative opacity is always assigned to a negative density, as illustrated in FIGS. 5A to 5E as an example, and a density being negative will be treated as an opacity being negative.

### <Logical Configuration of Information Processing Apparatus According to Second Embodiment>

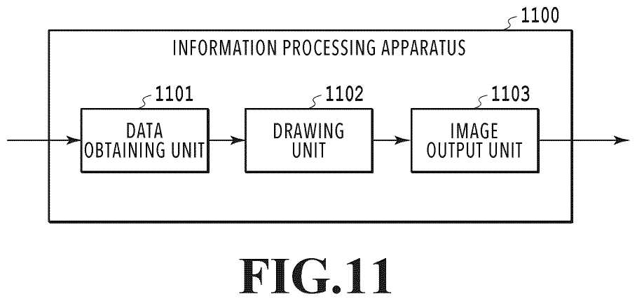

With reference to FIGS. 11 to 14E, an information processing apparatus 1100 according to a second embodiment (hereinafter, simply referred to as an “information processing apparatus 1100”) will be described. First, with reference to FIG. 11, a logical configuration of the information processing apparatus 1100 will be described. FIG. 11 is a block diagram illustrating an example of the logical configuration of the information processing apparatus 1100 according to the second embodiment. As the logical configuration, the information processing apparatus 1100 includes a data obtaining unit 1101, a drawing unit 1102, and an image output unit 1103.

The data obtaining unit 1101 obtains the trained 3D Gaussian model that is output from the information processing apparatus 200 according to the first embodiment and virtual viewpoint information that is to be used in a rendering process using the 3D Gaussian model. The trained 3D Gaussian model obtained by the data obtaining unit 1101 includes a negative-density 3D Gaussian distribution that corresponds to at least one negative opacity. Note that the 3D Gaussian model is data including one or more 3D Gaussian distributions that are arranged in a three-dimensional space and each of which has, as parameters, information pertaining to at least color, density, size, and rotation angle. The virtual viewpoint information includes information on the position of a virtual viewpoint, the direction of a line of sight at the virtual viewpoint, a rotation angle around a rotation axis that is the optical axis of a virtual image capturing apparatus (virtual camera) arranged at the virtual viewpoint, the focal length of the virtual camera, and a resolution that are to be used in the rendering process using the 3D Gaussian model. The following will describe assuming that information on color is represented with a set of three values of RGB, a set of three values of Lab, or a set of three values of Luv, or the coefficients of a spherical harmonics corresponding to three colors of any one of the sets of three values.

Based on the virtual viewpoint information obtained by the data obtaining unit 1101, the drawing unit 1102 performs the rendering process using the trained 3D Gaussian model obtained by the data obtaining unit 1101 to generate a drawn image. Specifically, the drawing unit 1102 first projects 3D Gaussian distributions included in the trained 3D Gaussian model onto a drawing plane that is determined based on the position of a virtual viewpoint and the direction of a line of sight at the virtual viewpoint. The drawing unit 1102 then accumulates colors and opacities in descending order of closeness to the virtual viewpoint to determine the color value of each pixel in the drawn image, thus generating the drawn image. The image output unit 1103 outputs the drawn image generated by the drawing unit 1102 as a virtual viewpoint image.

### <Hardware Configuration of Information Processing Apparatus According to Second Embodiment>

The hardware configuration of the information processing apparatus 1100 is the same as the hardware configuration of the information processing apparatus 200 according to the first embodiment, and thus the description thereof will be omitted. The processes performed by the units included in the information processing apparatus 1100 as its logical configuration are performed by processing hardware that is built in the information processing apparatus 1100, such as an ASIC, or performed by software using an arithmetic processing unit built in the information processing apparatus 1100, such as a CPU or a GPU, and a memory.

### <Operation of Information Processing Apparatus According to Second Embodiment>

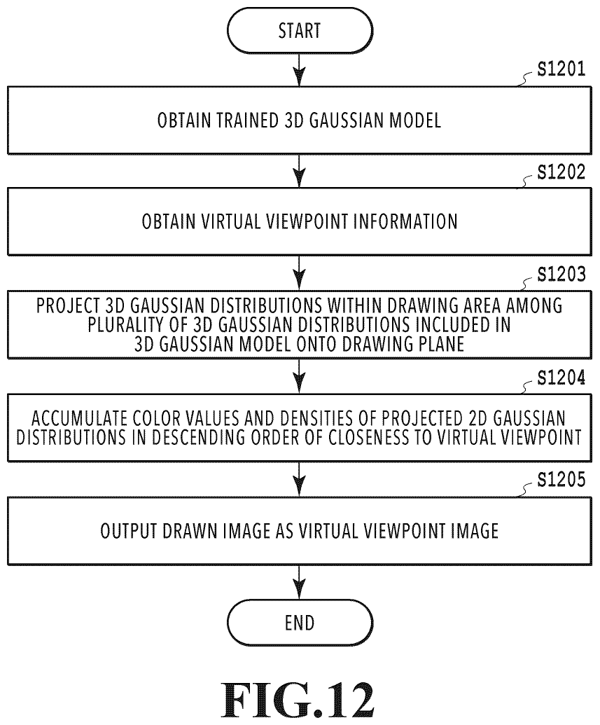

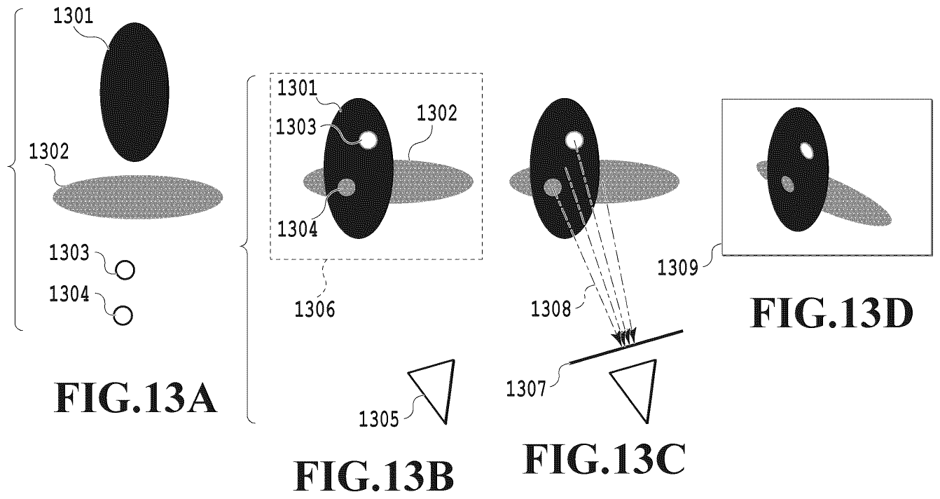

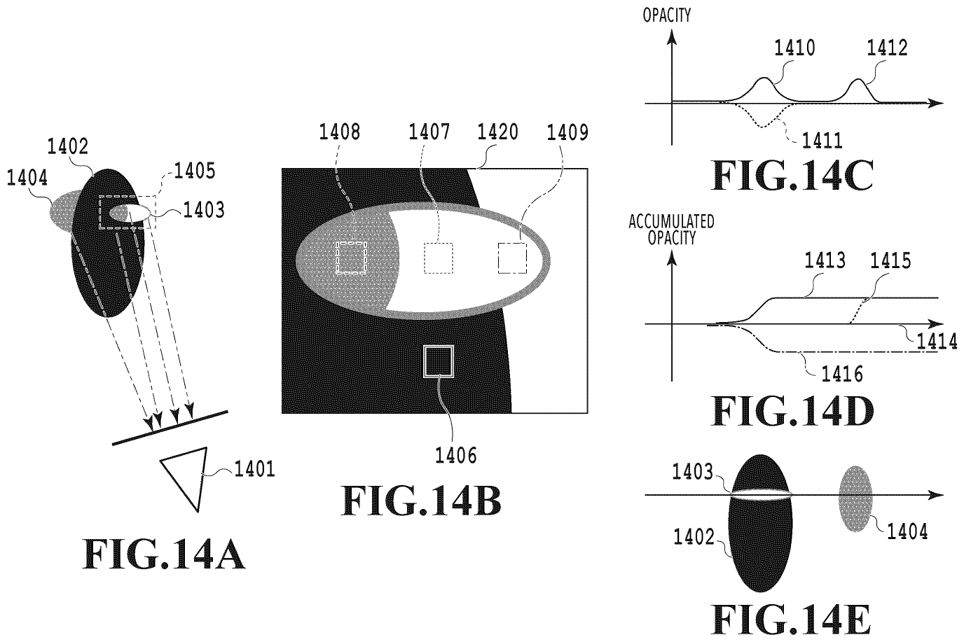

With reference to FIGS. 12 to 14E, the operation of the information processing apparatus 1100 will be described. FIG. 12 is a flowchart illustrating an example of a processing flow of the information processing apparatus 1100 according to the second embodiment. FIGS. 13A to 13D are diagrams for describing the operation of the information processing apparatus 1100 according to the second embodiment. FIGS. 14A to 14E are diagrams for describing a rendering process performed by the drawing unit 1102 according to the second embodiment.

First, in S1201, the data obtaining unit 1101 obtains the trained 3D Gaussian model and the virtual viewpoint information. The trained 3D Gaussian model obtained in S1201 includes one or more negative-density 3D Gaussian distributions. The virtual viewpoint information obtained in S1201 includes information on the position, orientation, resolution, principal point, and focal length of a virtual camera that corresponds to a drawing viewpoint that is to be used in the rendering process. FIG. 13A illustrates an example of 3D Gaussian distributions 1301 to 1304 that are included in the trained 3D Gaussian model obtained by the data obtaining unit 1101 in S1201. FIG. 13B illustrates the three-dimensional arrangement of the 3D Gaussian distributions 1301 to 1304 illustrated in FIG. 13A and a virtual viewpoint 1305. The 3D Gaussian distributions 1301 and 1302 are positive-density 3D Gaussian distributions corresponding to positive opacities, and the 3D Gaussian distributions 1303 and 1304 are negative-density 3D Gaussian distributions corresponding to negative opacities.

Next, in S1202, the drawing unit 1102 projects, among the 3D Gaussian distributions included in a trained 3D Gaussian model 1306, which is obtained in S1201, 3D Gaussian distributions that are targets of the rendering process corresponding to the virtual viewpoint 1305 onto a drawing plane. FIG. 13C illustrates, with broken arrows 1308, an example of how the 3D Gaussian distributions being the targets of the rendering process are projected onto a drawing plane 1307. Note that the drawing plane 1307 is a plane that is determined based on the virtual viewpoint information obtained in S1201. For example, the drawing plane 1307 is a plane that is orthogonal to a line extending in the direction of the line of sight at the virtual viewpoint from the position of the virtual viewpoint. The projecting process in S1202 is the same as the process of S701, which is described in the first embodiment with Equations (1) and (2), and thus detailed description thereof will be omitted.

Next, in S1203, the drawing unit 1102 generates a rendered image corresponding to each image capturing viewpoint (drawn image) through the rendering process in which the values of 3D Gaussian distributions projected onto the drawing plane are accumulated. Specifically, the drawing unit 1102 calculates the color values of the pixels of the drawn image by, for example, integrating the values of the projected 3D Gaussian distributions in descending order of closeness to the virtual viewpoint. FIG. 13D illustrates an example of a drawn image 1309 that is generated by the drawing unit 1102 in S1203. The rendering process in S1203 is the same as the process of S702, which is described in the first embodiment with Equations (3) to (5), and thus detailed description thereof will be omitted.

Next, in S1204, the image output unit 1103 outputs the drawn image 1309 generated in S1203 as a virtual viewpoint image. Specifically, for example, the image output unit 1103 outputs data of the virtual viewpoint image as a computer-readable file. The image output unit 1103 may output the virtual viewpoint image to a display unit included in the information processing apparatus 1100 to cause the display unit to display the virtual viewpoint image.

With reference to FIGS. 14A to 14E, there will be described a light-transmissive representation that is enabled in the 3D Gaussian Splatting by making a 3D Gaussian model include negative-density 3D Gaussian distributions corresponding to negative opacities and exceptional processing required by the light-transmissive representation. FIGS. 14A to 14E are diagrams for describing an example of the light-transmissive representation and exceptional processing in 3D Gaussian Splatting according to the second embodiment.

FIG. 14A illustrates how 3D Gaussian distributions 1402 to 1404 are projected onto a drawing plane corresponding to a virtual viewpoint 1401. In FIG. 14A, the 3D Gaussian distributions 1402 and 1404 are positive-density 3D Gaussian distributions, and the 3D Gaussian distribution 1404 is located behind the 3D Gaussian distribution 1402 as seen from the virtual viewpoint 1401. The 3D Gaussian distribution 1403 is a negative-density 3D Gaussian distribution. The 3D Gaussian distribution 1403 is a 3D Gaussian distribution that makes part of the positive-density 3D Gaussian distribution 1402 light-transmissive. FIG. 14E is a diagram of three 3D Gaussian distributions illustrated in FIG. 14A, the 3D Gaussian distributions 1402 to 1404, as seen from a direction orthogonal to the viewing direction at the virtual viewpoint 1401. That is, FIG. 14E illustrates how the 3D Gaussian distributions 1402 to 1404 are arranged in a depth direction. FIG. 14B illustrates an example of a rendered image 1420 corresponding to a region 1405 illustrated in FIG. 14A. Hereinafter, the process of drawing pixels 1406 to 1409 included in the rendered image 1420 will be described.

FIG. 14C illustrates an example of opacities that correspond to the 3D Gaussian distributions 1402 to 1404 in the viewing direction at the virtual viewpoint 1401, where the virtual viewpoint 1401 is the origin. FIG. 14D illustrates an example of accumulated opacities of a case where the opacities illustrated in FIG. 14C are accumulated in the viewing direction at the virtual viewpoint 1401 in descending order of closeness to the virtual viewpoint 1401. The pixel 1406 is a pixel that corresponds to a position onto which only the 3D Gaussian distribution 1402 is projected. The color value of the pixel 1406 is determined based on an accumulated opacity 1413 that is the accumulation of only a positive opacity 1410 corresponding to the positive-density 3D Gaussian distribution 1402.

The pixel 1407 is a pixel that corresponds to a position at which the 3D Gaussian distribution 1402 and the 3D Gaussian distribution 1403 are projected. The color value of the pixel 1407 is determined based on an accumulated opacity 1414 that is the accumulation of the positive opacity 1410 corresponding to the positive-density 3D Gaussian distribution 1402 and a negative opacity 1411 corresponding to the negative-density 3D Gaussian distribution 1403. Since the opacity 1410 and the opacity 1411 differ from each other in sign, the opacities are canceled. As a result, the rendering process based on the accumulated opacity 1414 makes the pixel 1407 have a color value corresponding to a background as in a case where there is no 3D Gaussian distribution.

The pixel 1408 is a pixel that corresponds to a position at which the 3D Gaussian distributions 1402 to 1404 are projected. The opacities corresponding to the 3D Gaussian distributions 1402 and 1403 are canceled. As a result, the color value of the pixel 1408 is determined based on an accumulated opacity 1415 that is the accumulation of only a positive opacity 1412 corresponding to the positive-density 3D Gaussian distribution 1404, which is farther away than the 3D Gaussian distribution 1402. As a result, in a case where the rendering process based on the accumulated opacity 1415 is performed, the 3D Gaussian distribution 1402 is made light-transmissive, and thus the pixel 1408 has a color value corresponding to the 3D Gaussian distribution 1404.

The pixel 1409 is a pixel that corresponds to a position at which only the 3D Gaussian distribution 1403 is projected. The color value of the pixel 1409 is determined based on an accumulated opacity 1416 that is the accumulation of only a negative opacity 1411 corresponding to the negative-density 3D Gaussian distribution 1403. However, if the rendering process based on the accumulated opacity 1416 is performed, the pixel 1409 is made to have a negative color value, and this state will fail to represent a drawn image. For this reason, the drawing unit 1102 needs to perform exceptional processing on the color values of pixels the accumulated opacities of which are negative values, such as the pixel 1409. Specifically, for example, the drawing unit 1102 performs the exceptional processing of setting the color values of the pixels to given colors corresponding to a background and the like, ignoring all 3D Gaussian distributions projected onto the positions of the pixels, for pixels the accumulated opacities of which are negative values.

Note that a negative-density 3D Gaussian distribution corresponding to a negative opacity may be appropriately corrected by the process of training a 3D Gaussian model according to the first embodiment such that only the 3D Gaussian distributions are not projected at a given pixel on a drawing plane. However, this does not guarantee that the color values of pixels are positive values in all drawn images corresponding to all virtual viewpoints generated using all trained 3D Gaussian models obtained as a result of diverse types of training. For this reason, the above-described exceptional processing is needed in the rendering process using the trained 3D Gaussian model.

With the information processing apparatus 1100 configured as described above, it is possible to generate a virtual viewpoint image corresponding to a virtual viewpoint using the trained 3D Gaussian model the amount of data of which is reduced by using negative-density 3D Gaussian distributions corresponding to negative opacities. With the information processing apparatus 1100, the use of such a trained 3D Gaussian model makes it possible to decrease the amount of computation in the rendering process compared with a case of using a conventional trained 3D Gaussian model including only positive-density 3D Gaussian distributions.

### Modification 1 of Second Embodiment

In the second embodiment, an aspect in which a virtual viewpoint image is generated using the trained 3D Gaussian model output from the information processing apparatus 200 according to the first embodiment has been described. However, the trained 3D Gaussian model obtained by the information processing apparatus 1100 may be edited by a user, and the trained 3D Gaussian model that has been edited may be used to generate a virtual viewpoint image. For example, if a user performs an edit to the trained 3D Gaussian model such that a negative-density 3D Gaussian distribution corresponding to a negative opacity is added to the trained 3D Gaussian model, a rendering process in which a part of a positive-density 3D Gaussian distribution included in the original trained 3D Gaussian model is made light-transmissive may be performed. For example, the drawing unit 1102 adds or deletes a negative-density 3D Gaussian distribution to or from the trained 3D Gaussian model obtained by the data obtaining unit or changes parameters of the trained 3D Gaussian model, based on an editing operation from a user that is received by the operation unit 308. For example, if a user performs an edit to the trained 3D Gaussian model obtained by the data obtaining unit such that a negative-density 3D Gaussian distribution is added to the trained 3D Gaussian model, a part of a positive-density 3D Gaussian distribution included in the trained 3D Gaussian model may be made light-transmissive.

Note that, in a case where a negative-density 3D Gaussian distribution that may make a part of a positive-density 3D Gaussian distribution light-transmissive is to be added to the trained 3D Gaussian model obtained by the data obtaining unit, it is necessary to determine parameters of the 3D Gaussian distribution to be added, as described below for example. The following will describe a method for determining the parameters of the 3D Gaussian distribution 1403 to make a part of the 3D Gaussian distribution 1402 illustrated in FIG. 14A light-transmissive by adding the 3D Gaussian distribution 1403 to the 3D Gaussian distribution 1402 based on an editing operation by a user in such a manner that the 3D Gaussian distribution 1403 is superimposed on the 3D Gaussian distribution 1402. A color value C(p₁₄₀₈) of the pixel 1408 that may be calculated using Equation (3), which is used in the description of the first embodiment, is expanded based on Equation (3) as Equation (11) shown below.

$$\begin{matrix}[ Equation 11 ] & \\ c ( {p}_{1408} ) = {\sum }_{i ∈ N} {c}_{i} {f}_{i}^{2 D} ( {p}_{1408} ) {\prod }_{j = 1}^{i - 1} 1 - {f}_{j}^{2 D} ( 1408 ) = {c}_{1402} {f}_{1402} ( {p}_{1408} ) + {c}_{1403} {f}_{1403} ( {p}_{1408} ) ( 1 - {f}_{1402} ( {p}_{1408} ) ) + {c}_{1404} {f}_{1404} ( {p}_{1408} ) ( 1 - {f}_{1402} ( {p}_{1408} ) ) ( 1 - {f}_{1403} ( {p}_{1408} ) ) & Equation ( 11 )\end{matrix}$$

Here, the condition for making the 3D Gaussian distribution 1402 light-transmissive and drawing the 3D Gaussian distribution 1404 present behind the 3D Gaussian distribution 1402 properly may be given by, for example, Equation (12) shown below.

$$\begin{matrix}[ Equation 12 ] & \\ \{ \begin{matrix}{c}_{1402} {f}_{1402} ( {p}_{1408} ) + {c}_{1403} {f}_{1403} ( {p}_{1408} ) ( 1 - {f}_{1402} ( {p}_{1408} ) ) = 0 \\ ( 1 - {f}_{1402} ( {p}_{1408} ) ) ( 1 - {f}_{1403} ( {p}_{1408} ) ) = 1\end{matrix} & Equation ( 12 )\end{matrix}$$

Furthermore, expanding Equation (12) yields Equation (13) shown below.

$$\begin{matrix}[ Equation 13 ] & \\ \{ \begin{matrix}{c}_{1403} = {c}_{1402} \\ {f}_{1403} ( {p}_{1408} ) = - \frac{{f}_{1402} ( {p}_{1408} )}{1 - {f}_{1402} ( {p}_{1408} )}\end{matrix} & Equation ( 13 )\end{matrix}$$

Adding the 3D Gaussian distribution 1403 that overlaps the 3D Gaussian distribution 1402 in a case where the condition given by Equation (13) is satisfied provides a representation in which part of the 3D Gaussian distribution 1402 is made light-transmissive. Note that, in Equation (13), “1402” and “1403” are interchangeable. As a result, even if the positions in the depth direction of the 3D Gaussian distribution 1402 and the 3D Gaussian distribution 1403 overlapping each other are switched, and thus the order in which their respective 2D Gaussian distributions are accumulated is reversed, the light-transmissive representation of the 3D Gaussian distribution 1402 may be provided because the same condition is satisfied.

For example, a user adds a negative-density 3D Gaussian distribution satisfying the above-described condition by editing a 3D Gaussian model while checking a drawn image (virtual viewpoint image) generated through the rendering process performed by the drawing unit 1102, which is displayed on the display unit included in the information processing apparatus 1100. Such editing allows the user to obtain a drawn image (virtual viewpoint image) in which a part of a positive-density 3D Gaussian distribution included in the 3D Gaussian model before the editing is made light-transmissive.

### Modification 2 of Second Embodiment

Thus far, it is assumed in the descriptions that a 3D Gaussian model includes 3D Gaussian distributions each of which has, as its parameters, information on its variances and covariances (size) corresponding to each of the directions of three axes, and the rotation angle (rotation matrix). However, this may be constrained. For example, the shape of each 3D Gaussian distribution may be limited to a spherical shape. In this case, each 3D Gaussian distribution has information, as its parameters, information on the radius of a sphere rather than information on a size corresponding to the directions of the axes and a rotation matrix. By limiting the shape of each 3D Gaussian distribution to a spherical shape, the amount of data on each 3D Gaussian distribution may be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to obtain a high-accuracy virtual viewpoint image while decreasing the amount of data of a 3D Gaussian model.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-218842, filed Dec. 13, 2024, which is hereby incorporated by reference herein in its entirety.

What is claimed is:

1. An information processing apparatus comprising:
one or more hardware processors; and
one or more memories storing one or more programs configured to be executed by the one or more hardware processors, the one or more programs including instructions for:
obtaining a plurality of captured images and camera parameters, the plurality of captured images being obtained by performing image capturing on a target space in a plurality of directions different from one another, the camera parameters corresponding to each of the plurality of captured images;
setting, based on the captured images and the camera parameters, initial values of parameters of a 3D Gaussian model that includes a plurality of 3D Gaussian distributions, the plurality of 3D Gaussian distributions including at least one 3D Gaussian distribution having a value of a density corresponding to a negative opacity and at least one 3D Gaussian distribution having a value of a density corresponding to a positive opacity; and
obtaining a trained 3D Gaussian model that reproduces the target space by optimizing the parameters of the 3D Gaussian model through training based on the captured images and the camera parameters.

2. The information processing apparatus according to claim 1, wherein the one or more programs further include instructions for
arranging, based on the captured images, the 3D Gaussian distribution having the value of the density corresponding to the positive opacity being an initial 3D Gaussian distribution at a position corresponding to a three-dimensional surface of an object present in the target space, the three-dimensional surface being obtained by estimating a three-dimensional shape of the object, and
arranging the 3D Gaussian distribution having the value of the density corresponding to the negative opacity being an initial 3D Gaussian distribution at a position at a predetermined distance from the initial 3D Gaussian distribution having the value of the density corresponding to the positive opacity.

3. The information processing apparatus according to claim 1, wherein the one or more programs further include instructions for
arranging the initial plurality of 3D Gaussian distributions regularly or randomly in a space that contains the three-dimensional shape of the object obtained by estimating based on the captured images.

4. The information processing apparatus according to claim 1, wherein the one or more programs further include instructions for
replacing two or more 3D Gaussian distributions, among the initial plurality of 3D Gaussian distributions, with one initial 3D Gaussian distribution that contains the two or more 3D Gaussian distributions, the two or more 3D Gaussian distributions being close to one another in position and being similar to one another in information pertaining to an initial color that is set based on the captured images.

5. The information processing apparatus according to claim 1, wherein the one or more programs further include instructions for
updating, in the training, a total number of the parameters of the 3D Gaussian model and a total number of 3D Gaussian distributions included in the 3D Gaussian model in a case where there is a pixel a value of an accumulated opacity of which or a color of which calculated in a rendering process using the 3D Gaussian model is negative.

6. The information processing apparatus according to claim 1, wherein the one or more programs further include instructions for
updating, in the training, the 3D Gaussian model such that a total number of the plurality of 3D Gaussian distributions included in the 3D Gaussian model is reduced.

7. The information processing apparatus according to claim 1, wherein the one or more programs further include instructions for
deleting, in the training, a 3D Gaussian distribution from the 3D Gaussian model, the 3D Gaussian distribution having an opacity an absolute value of which is small among the plurality of 3D Gaussian distributions included in the 3D Gaussian model.

8. The information processing apparatus according to claim 1, wherein the one or more programs further include instructions for
deleting, in the training, a pair of 3D Gaussian distributions among the plurality of 3D Gaussian distributions included in the 3D Gaussian model, the pair of 3D Gaussian distributions being similar to each other in position, variances and covariances, and color and having densities a total value of which is close to zero.

9. The information processing apparatus according to claim 1, wherein the one or more programs further include instructions for
arranging, in the training, in a vicinity of 3D Gaussian distribution values of variances and covariances of which are larger than a size of an object represented by the 3D Gaussian distribution among the plurality of 3D Gaussian distributions included in the 3D Gaussian model, a 3D Gaussian distribution that is different in a value of color or density from the 3D Gaussian distribution the values of the variances and covariances of which are larger than the size of the object.

10. The information processing apparatus according to claim 1, wherein the one or more programs further include instructions for
arranging, in the training, a 3D Gaussian distribution having the value of the density corresponding to the negative opacity within a region of a shape of the 3D Gaussian distribution having the value of the density corresponding to the positive opacity, the 3D Gaussian distribution having the value of the density corresponding to the negative opacity being associated with the 3D Gaussian distribution having the value of the density corresponding to the positive opacity.

11. The information processing apparatus according to claim 1, wherein
the parameters of the trained 3D Gaussian model include information on a position, a covariance matrix, density information, and a color of each of the plurality of 3D Gaussian distributions.

12. The information processing apparatus according to claim 1, wherein the one or more programs further include instructions for
outputting the trained 3D Gaussian model that is obtained.

13. The information processing apparatus according to claim 12, wherein the one or more programs further include instructions for
outputting, in a case where a conversion function other than a predetermined function is used in a process of conversion between density and opacity in the training, information on the conversion function in association with data on the trained 3D Gaussian model.

14. An information processing apparatus comprising:
one or more hardware processors; and
one or more memories storing one or more programs configured to be executed by the one or more hardware processors, the one or more programs including instructions for:
obtaining a trained 3D Gaussian model and virtual viewpoint information, the trained 3D Gaussian model including a plurality of 3D Gaussian distributions each including information on a position, variances and covariances, a density, and a color, the virtual viewpoint information including information pertaining to a virtual viewpoint;
determining, based on the trained 3D Gaussian model and the virtual viewpoint information, color values of pixels in a virtual viewpoint image corresponding to the virtual viewpoint by accumulating opacities and colors of 3D Gaussian distributions that correspond to the virtual viewpoint among the plurality of 3D Gaussian distributions included in the trained 3D Gaussian model and are projected onto a drawing plane corresponding to the virtual viewpoint in descending order of closeness to the virtual viewpoint, the opacities corresponding to values of densities of the 3D Gaussian distributions and distances to centers of the 3D Gaussian distributions, and
generating the virtual viewpoint image by assigning a negative opacity to a 3D Gaussian distribution a value of a density of which is smaller than a predetermined threshold.

15. The information processing apparatus according to claim 14, wherein the one or more programs further include instructions for
replacing, in the virtual viewpoint image, a color value of a pixel at which a value of accumulated opacities is negative or a pixel at which a value of an accumulated color is negative, with a predetermined color value.

16. An information processing method comprising the steps of:
obtaining a plurality of captured images and camera parameters, the plurality of captured images being obtained by performing image capturing on a target space in a plurality of directions different from one another, the camera parameters corresponding to each of the plurality of captured images;
setting, based on the captured images and the camera parameters, initial values of parameters of a 3D Gaussian model that includes a plurality of 3D Gaussian distributions, the plurality of 3D Gaussian distributions including at least one 3D Gaussian distribution having a value of a density corresponding to a negative opacity and at least one 3D Gaussian distribution having a value of a density corresponding to a positive opacity; and
obtaining a trained 3D Gaussian model that reproduces the target space by optimizing the parameters of the 3D Gaussian model through training based on the captured images and the camera parameters.

17. An information processing method comprising the steps of:
obtaining a trained 3D Gaussian model and virtual viewpoint information, the trained 3D Gaussian model including a plurality of 3D Gaussian distributions each including information on a position, variances and covariances, a density, and a color, the virtual viewpoint information including information pertaining to a virtual viewpoint;
determining, based on the trained 3D Gaussian model and the virtual viewpoint information, color values of pixels in a virtual viewpoint image corresponding to the virtual viewpoint by accumulating opacities and colors of 3D Gaussian distributions that correspond to the virtual viewpoint among the plurality of 3D Gaussian distributions included in the trained 3D Gaussian model and are projected onto a drawing plane corresponding to the virtual viewpoint in descending order of closeness to the virtual viewpoint, the opacities corresponding to values of densities of the 3D Gaussian distributions and distances to centers of the 3D Gaussian distributions; and
generating the virtual viewpoint image by assigning a negative opacity to a 3D Gaussian distribution a value of a density of which is smaller than a predetermined threshold.

18. A non-transitory computer readable storage medium storing a program for causing a computer to perform a control method of an information processing apparatus, the control method comprising the steps of:
obtaining a plurality of captured images and camera parameters, the plurality of captured images being obtained by performing image capturing on a target space in a plurality of directions different from one another, the camera parameters corresponding to each of the plurality of captured images;
setting, based on the captured images and the camera parameters, initial values of parameters of a 3D Gaussian model that includes a plurality of 3D Gaussian distributions, the plurality of 3D Gaussian distributions including at least one 3D Gaussian distribution having a value of a density corresponding to a negative opacity and at least one 3D Gaussian distribution having a value of a density corresponding to a positive opacity; and
obtaining a trained 3D Gaussian model that reproduces the target space by optimizing the parameters of the 3D Gaussian model through training based on the captured images and the camera parameters.

19. A non-transitory computer readable storage medium storing a program for causing a computer to perform a control method of an information processing apparatus, the control method comprising the steps of:
obtaining a trained 3D Gaussian model and virtual viewpoint information, the trained 3D Gaussian model including a plurality of 3D Gaussian distributions each including information on a position, variances and covariances, a density, and a color, the virtual viewpoint information including information pertaining to a virtual viewpoint;
determining, based on the trained 3D Gaussian model and the virtual viewpoint information, color values of pixels in a virtual viewpoint image corresponding to the virtual viewpoint by accumulating opacities and colors of 3D Gaussian distributions that correspond to the virtual viewpoint among the plurality of 3D Gaussian distributions included in the trained 3D Gaussian model and are projected onto a drawing plane corresponding to the virtual viewpoint in descending order of closeness to the virtual viewpoint, the opacities corresponding to values of densities of the 3D Gaussian distributions and distances to centers of the 3D Gaussian distributions; and
generating the virtual viewpoint image by assigning a negative opacity to a 3D Gaussian distribution a value of a density of which is smaller than a predetermined threshold.
